(19) United States
(12) Patent Application Publication
(10) Pub. No.: US 2024/0062949 A1
(43) Pub. Date: Feb. 22, 2024

(54) COIL COMPONENT

(71) Applicant: TDK Corporation, Tokyo (JP)

(72) Inventors: Masaki ENDO, Tokyo (JP); Tomonaga NISHIKAWA, Tokyo (JP); Mitsuru MIURA, Tokyo (JP); Eisuke YONEKURA, Tokyo (JP); Akira MOTOHASHI, Tokyo (JP)

(21) Appl. No.: 18/366,316

(22) Filed: Aug. 7, 2023

(30) Foreign Application Priority Data
Aug. 18, 2022 (JP) 2022-130393

(51) Int. Cl. H01F 27/29

(52) U.S. Cl. CPC H01F 27/292

(57) ABSTRACT

Disclosed herein is a coil component that includes a coil conductor embedded in the element body; a first bump conductor exposed to the mounting surface and the first and side surfaces; a second bump conductor exposed to the mounting surface and the second and fourth side surfaces; a first dummy bump conductor exposed to the mounting surface and the first and fourth side surfaces; a second dummy bump conductor exposed to the mounting surface and the second and third side surfaces; a first conductive resin layer connecting the first bump conductor and first dummy bump conductor; and a second conductive resin layer connecting the second bump conductor and the second dummy bump conductor. The first and bump conductors and the first and second dummy bump conductors are not covered at least partly with the first conductive resin layer.

### BACKGROUND OF THE ART

### Field of the Art

The present disclosure relates to a coil component and, more particularly, to a two-terminal type coil component in which a single coil conductor is incorporated in an element body.

### Description of Related Art

As a two-terminal type coil component in which a single coil conductor is incorporated in an element body, a coil component described in JP 01-167023A is known. As described in JP 01-167023A, coil components of such a type generally employ a so-called five-surface electrode structure, in which a pair of external terminals each cover five surfaces of an element body.

However, the five-surface electrode is generally made of conductive resin or the like, so that when a coil component of such a type is mounted on a circuit board using a solder or the like, it disadvantageously has an increased connection resistance with respect to the circuit board.

### SUMMARY

It is therefore an object of the present disclosure to reduce a connection resistance in a two-terminal type coil component in which a single coil conductor is incorporated in an element body.

A coil component according to the present disclosure includes: an element body having a mounting surface, first and second side surfaces which are perpendicular to the mounting surface and parallel to each other, and third and fourth side surfaces which are perpendicular to the mounting surface and the first surface and parallel to each other; a coil conductor embedded in the element body; a first bump conductor which is connected to one end of the coil conductor and exposed to the mounting surface, the first side surface, and the third side surface; a second bump conductor which is connected to the other end of the coil conductor and exposed to the mounting surface, the second side surface, and one of the third and fourth side surfaces; a first dummy bump conductor which is exposed to the mounting surface, the first side surface and the fourth side surface; a second dummy bump conductor which is exposed to the mounting surface, the second side surface, and the other one of the third and fourth side surfaces; a first conductive resin layer which is formed on the mounting surface and connects the first bump conductor and first dummy bump conductor; and a second conductive resin layer which is formed on the mounting surface and connects the second bump conductor and the second dummy bump conductor. First side surface parts of the first bump conductor and first dummy bump conductor that are exposed to the first, third, and fourth side surfaces are each not covered at least partly with the first conductive resin layer, and second side surface parts of the second bump conductor and second dummy bump conductor that are exposed to the second, third, and fourth side surfaces are each not covered at least partly with the second conductive resin layer.

### BRIEF DESCRIPTION OF THE DRAWINGS

The above features and advantages of the present disclosure will be more apparent from the following description of certain preferred embodiments taken in conjunction with the accompanying drawings, in which:

FIGS. 1 and 2 are schematic perspective views illustrating the outer appearance of a coil component 100 according to an embodiment of the present disclosure as viewed in different directions;

FIG. 3 is a schematic plan view illustrating pattern shape of the conductor layer L1;

FIG. 4 is a schematic plan view illustrating pattern shape of the conductor layer L2;

FIG. 5 is a schematic plan view illustrating pattern shape of the conductor layer L3;

FIG. 6 is a schematic plan view illustrating pattern shape of the conductor layer L4;

FIG. 7 is a schematic plan view illustrating pattern shape of the conductor layer L5;

FIG. 8 is a YZ cross-sectional view of the coil component 100;

FIG. 9 is a YZ cross-sectional view of the coil component according to a modification;

FIG. 10 is a schematic partial plan view of a circuit board 200 on which the coil component 100 is mounted; and

FIG. 11 is a schematic partial plan view of the coil component 100 mounted on the circuit board 200.

### DETAILED DESCRIPTION OF THE EMBODIMENTS

Preferred embodiments of the present disclosure will be explained below in detail with reference to the accompanying drawings.

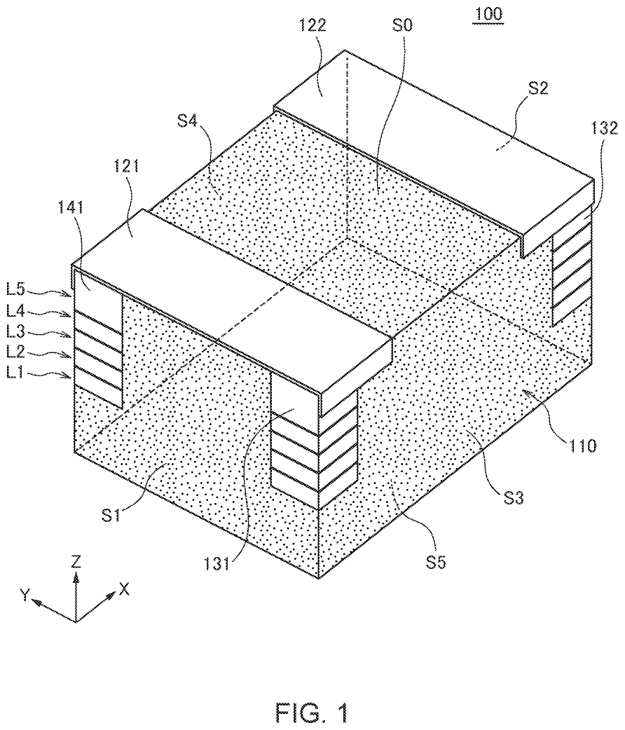

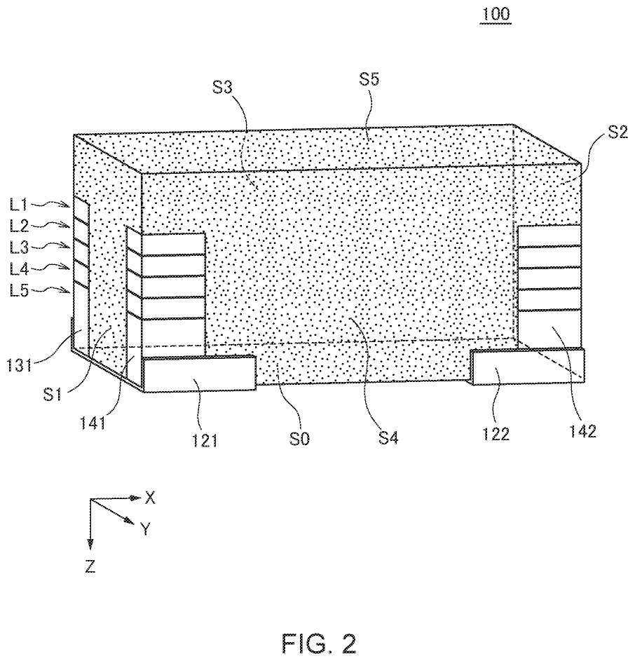

FIGS. 1 and 2 are schematic perspective views illustrating the outer appearance of a coil component 100 according to an embodiment of the present disclosure as viewed in different directions.

As illustrated in FIGS. 1 and 2, the coil component 100 according to the present embodiment has an element body 110 and a pair of conductive resin layers 121 and 122 that cover the surface of the element body 110. The element body 110 is made of a composite magnetic material containing magnetic filer made a magnetic metal body and a resin binder, inside of which a coil conductor to be described later is embedded. The element body 110 has a mounting surface S0, an upper surface S5, side surfaces S1 and S2, and side surfaces S3 and S4. The mounting surface S0 and upper surface S5 constitute an XY plane, the side surfaces S1 and S2 constitute a YZ plane, and the side surfaces S3 and S4 constitute an XZ plane. In actual use, the coil component 100 is mounted on a circuit board such that the mounting surface S0 faces the surface of the circuit board. Thus, the side surfaces S1 to S4 are perpendicular to the mounting surface S0, the side surfaces S1 and S2 are parallel to each other, and the side surfaces S3 and S4 are parallel to each other. The side surfaces S1, S2 are perpendicular to the side surfaces S3, S4.

Bump conductors 131, 132, and dummy bump conductors 141, 142 are exposed to the surfaces of the element body 110. The bump conductor 131 is connected to one end of the coil conductor embedded in the element body 110, and the bump conductor 132 is connected to the other end of the coil conductor embedded in the element body 110. The dummy bump conductors 141 and 142 are not directly connected to the coil conductor but connected respectively to the bump conductors 131 and 132 through the respective conductive resin layers 121 and 122. The bump conductor 131 is exposed to three surfaces of the mounting surface S0 and side surfaces S1 and S3, and the bump conductor 132 is exposed to three surfaces of the mounting surface S0 and side surfaces S2 and S3. The dummy bump conductor 141 is exposed to three surfaces of the mounting surface S0 and side surfaces S1 and S4, and the dummy bump conductor 142 is exposed to three surfaces of the mounting surface S0 and side surfaces S2 and S4.

The conductive resin layers 121 and 122 are made of a conductive material, such as silver paste, containing metal power and a resin binder and are formed at least on the mounting surface S0 of the element body 110. The conductive resin layer 121 connects the bump conductor 131 and the dummy bump conductor 141, and the conductive resin layer 122 connects the bump conductor 132 and the dummy bump conductor 142. In the example illustrated in FIGS. 1 and 2, the conductive resin layers 121 and 122 each partly cover the side surfaces S3 and S4 of the element body 110, while at least a part of the side surface part of each of the bump conductor (131, 132) and dummy bump conductor (142, 142) that is exposed to the side surfaces (S1 to S4) is not covered with the conductive resin layer (121, 122). The side surface part of the bump conductor 131 refers to a part thereof exposed to the side surfaces S1 and S3, the side surface part of the bump conductor 132 refers to a part thereof exposed to the side surfaces S2 and S3, the side surface part of the dummy bump conductor 141 refers to a part thereof exposed to the side surfaces S1 and S4, and the side surface part of the dummy bump conductor 142 refers to a part thereof exposed to the side surfaces S2 and S4.

In the example illustrated in FIGS. 1 and 2, the conductive resin layer 121 does not cover a part of each of the bump conductor 131 and dummy bump conductor 141 that is exposed to the side surface S1. Similarly, the conductive resin layer 122 does not cover a part of each of the bump conductor 132 and dummy bump conductor 142 that is exposed to the side surface S2. Thus, the area of a part of the side surface part of each of the bump conductor (131, 132) and dummy bump conductor (141, 142) that is exposed without being covered by the conductive resin layer (121, 122) can be sufficiently ensured. In this case, the conductive resin layer (121, 122) constitutes a so-called L-shaped electrode on each of the bump conductor (131, 132) and dummy bump conductor (141, 142).

Alternatively, a part of each of the bump conductor 131 and dummy bump conductor 141 that is exposed to the side surface S1 may be partly covered with the conductive resin layer 121, and a part of each of the bump conductor 132 and dummy bump conductor 142 that is exposed to the side surface S2 may partly be covered with the conductive resin layer 122. In this case, a part of the conductive resin layer 121 that covers the bump conductor 131 and the dummy bump conductor 141 that are exposed respectively to the side surfaces S3 and S4 may be larger in thickness than a part of the conductive resin layer 121 that covers the bump conductor 131 and dummy bump conductor 141 that are exposed to the side surface S1. Similarly, a part of the conductive resin layer 122 that covers the bump conductor 132 and the dummy bump conductor 142 that are exposed respectively to the side surfaces S3 and S4 may be larger in thickness than a part of the conductive resin layer 122 that covers the bump conductor 132 and dummy bump conductor 142 that are exposed to the side surface S2. This makes rotational displacement of mounting position (to be described later) unlikely to occur.

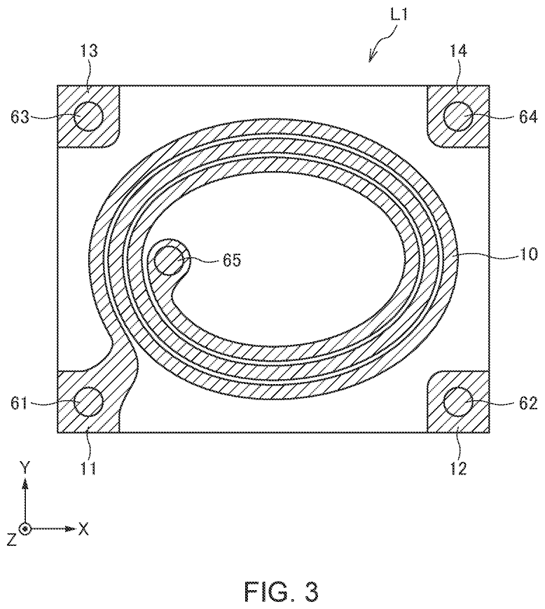

For example, five conductor layers L1 to L5 are embedded inside the element body 110 to constitute a coil conductor. The conductor layers L1 to L5 are each made of a material lower in resistance than at least the conductive resin layers 121 and 122. For example, the conductor layers L1 to L5 are made of copper (Cu). FIGS. 3 to 7 are schematic plan views illustrating pattern shapes of the conductor layers L1 to L5, respectively.

As illustrated in FIG. 3, the conductor layer L1 has a coil pattern 10 and connection patterns 11 to 14. The outer peripheral end of the coil pattern 10 is connected to the connection pattern 11. The connection patterns 12 to 14 are not connected to the coil pattern 10 within the same plane and are independent of one another within the same plane.

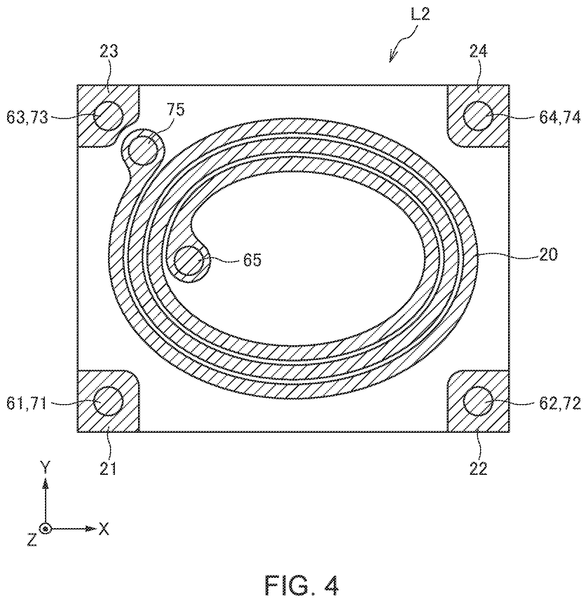

As illustrated in FIG. 4, the conductor layer L2 has a coil pattern 20 and connection patterns 21 to 24. The inner peripheral end of the coil pattern 20 is connected to the inner peripheral end of the coil pattern 10 through a via hole 65. The connection patterns 21 to 24 are not connected to the coil pattern 20 within the same plane and are independent of one another within the same plane. The connection patterns 21 to 24 are connected respectively to the connection patterns 11 to 14 through respective via holes 61 to 64.

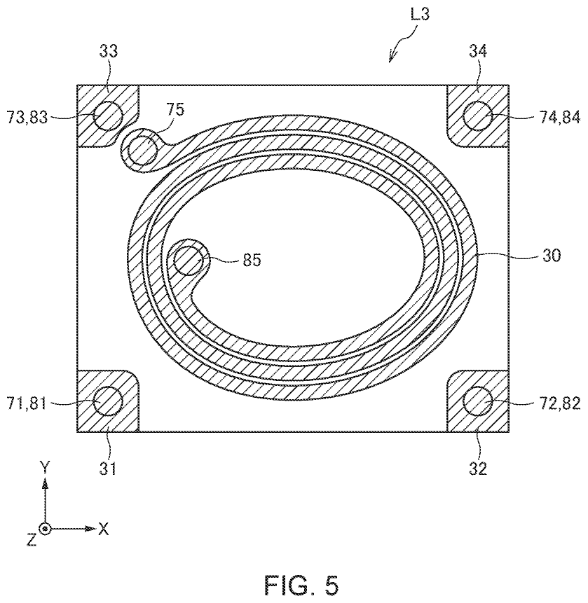

As illustrated in FIG. 5, the conductor layer L3 has a coil pattern 30 and connection patterns 31 to 34. The outer peripheral end of the coil pattern 30 is connected to the outer peripheral end of the coil pattern 20 through a via hole 75. The connection patterns 31 to 34 are not connected to the coil pattern 30 within the same plane and are independent of one another within the same plane. The connection patterns 31 to 34 are connected respectively to the connection patterns 21 to 24 through respective via holes 71 to 74.

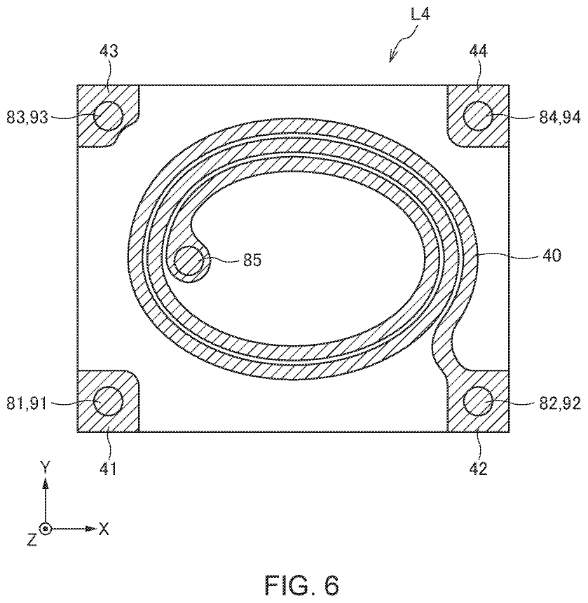

As illustrated in FIG. 6, the conductor layer L4 has a coil pattern 40 and connection patterns 41 to 44. The inner peripheral end of the coil pattern 40 is connected to the inner peripheral end of the coil pattern 30 through a via hole 85. The outer peripheral end of the coil pattern 40 is connected to the connection pattern 42. The connection patterns 41, 43, and 44 are not connected to the coil pattern 40 within the same plane and are independent of one another within the same plane. The connection patterns 41 to 44 are connected respectively to the connection patterns 31 to 34 through respective via holes 81 to 84.

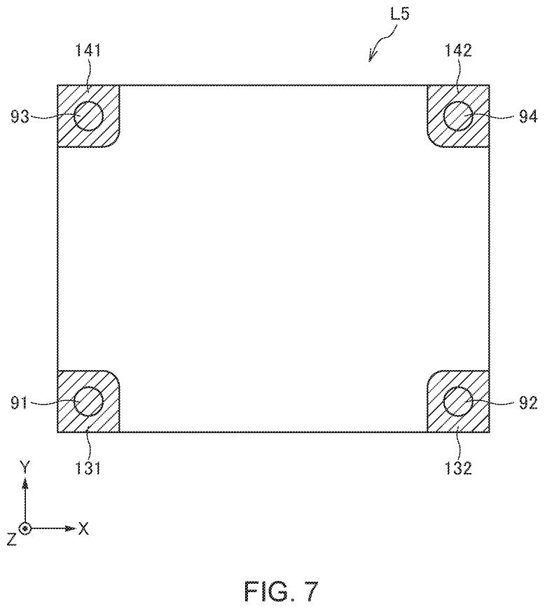

As illustrated in FIG. 7, the conductor layer L5 has the bump conductors 131 and 132 and dummy bump conductors 141 and 142. The bump conductors 131 and 132 and dummy bump conductors 141 and 142 are connected respectively to the connection patterns 41 to 44 through respective via holes 91 to 94.

With the above configuration, one and the other ends of the coil conductor composed of the coil patterns 10, 20, 30, and 40 are connected respectively to the bump conductors 131 and 132. As illustrated in FIGS. 1 and 2, the bump conductor 131 and the dummy bump conductor 141 are connected to each other through the conductive resin layer 121, and the bump conductor 132 and the dummy bump conductor 142 are connected to each other through the conductive resin layer 122. Thus, although the coil component 100 according to the present embodiment is a two-terminal type coil component in which a single coil conductor is incorporated in the element body 110, it has a terminal structure similar to a four-terminal type coil component due to the presence of the two dummy bump conductors 141 and 142.

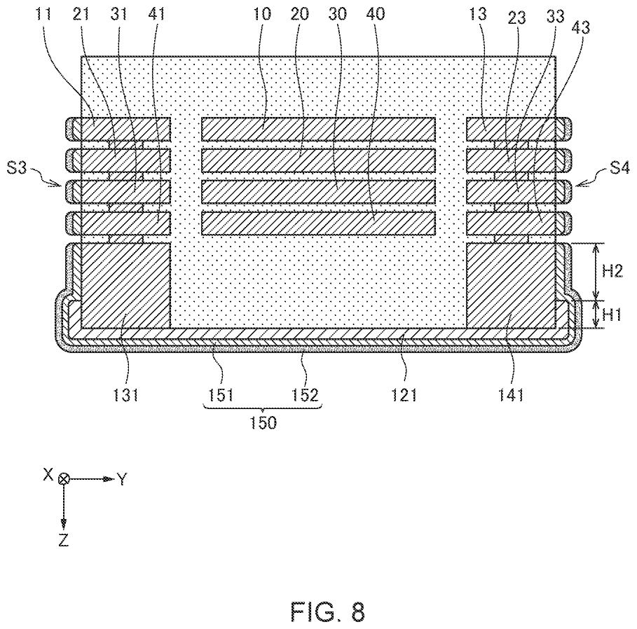

FIG. 8 is a YZ cross-sectional view of the coil component 100 according to the present embodiment.

As illustrated in FIG. 8, the surfaces of the conductor layers L1 to L5 exposed from the element body 110 and the surfaces of the conductive resin layers 121 and 122 are covered with a surface treatment layer 150. The surface treatment layer 150 acts to enhance wettability to a solder and is formed of a laminated film of an Ni film 151 and an Sn film 152, for example. A part of the surface treatment layer 150 is directly formed on the side surface parts of the bump conductors 131 and 132 and dummy bump conductors 141 and 142 not through the conductive resin layers 121 and 122. Thus, as compared to when the entire surfaces of the bump conductors 131 and 132 and dummy bump conductors 141 and 142 are covered with a relatively high-resistance conductive resin layers 121 and 122, resistance values between the surface treatment layer 150 and bump conductors 131 and 132 and between the surface treatment layer 150 and the dummy bump conductors 141 and 142 are reduced. On the other hand, the conductive resin layers 121 and 122 have high flexibility and thus acts to enhance stress relaxation characteristics.

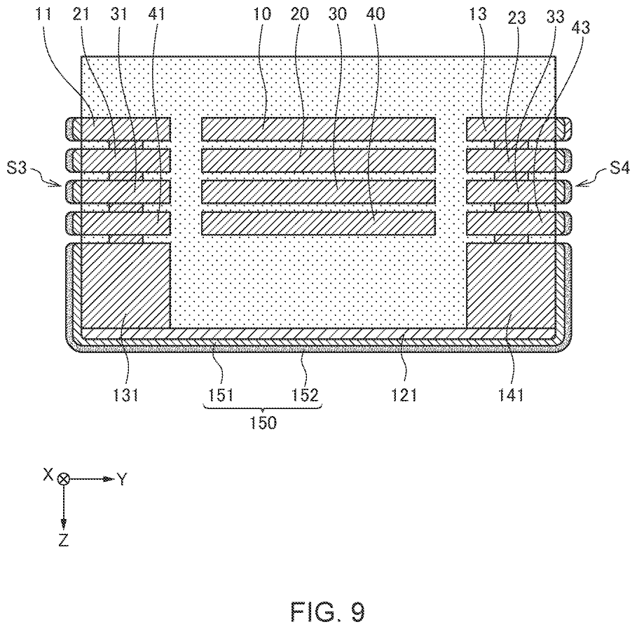

Further, in the present embodiment, the conductive resin layers 121 and 122 partly go around to the side surfaces S3 and S4 of the element body 110, and thus the side surface parts of the bump conductors 131 and 132 and dummy bump conductors 141 and 142 are partly covered with the conductive resin layers 121 and 122. Such a structure further enhances stress relaxation characteristics. Even in this case, a height H1 in the z-direction of a part of the side surface part that is covered with each of the conductive resin layers 121 and 122 is preferably smaller than a height H2 in the z-direction of a part of the side surface part that is not covered with each of the conductive resin layers 121 and 122. With this configuration, the contact areas between the surface treatment layer 150 and the bump conductors 131 and 132 and between the surface treatment layer 150 and the dummy bump conductors 141 and 142 are sufficiently ensured. However, in the present disclosure, it is not essential that the conductive resin layers 121 and 122 partly go around to the side surfaces S3 and S4 of the element body 110, and the conductive resin layers 121 and 122 may be provided only on the mounting surface S0 of the element body 110, as illustrated in the YZ cross-sectional view of FIG. 9. This further reduces a connection resistance.

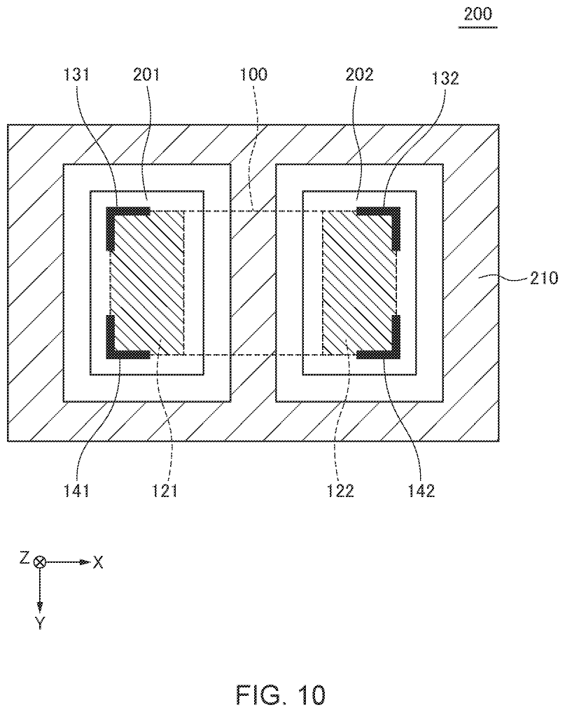

FIG. 10 is a schematic partial plan view of a circuit board 200 on which the coil component 100 according to the present embodiment is mounted.

In the circuit board 200 illustrated in FIG. 10, an XY surface, which is the main surface, is mostly covered with a solder resist 210, and a pair of land patterns 201 and 202 are exposed from the solder resist 210. The land patterns 201 and 202 are portions that face the conductive resin layers 121 and 122, respectively, of the coil component 100. In FIG. 10, the mounting position of the coil component 100 is denoted by a dashed line.

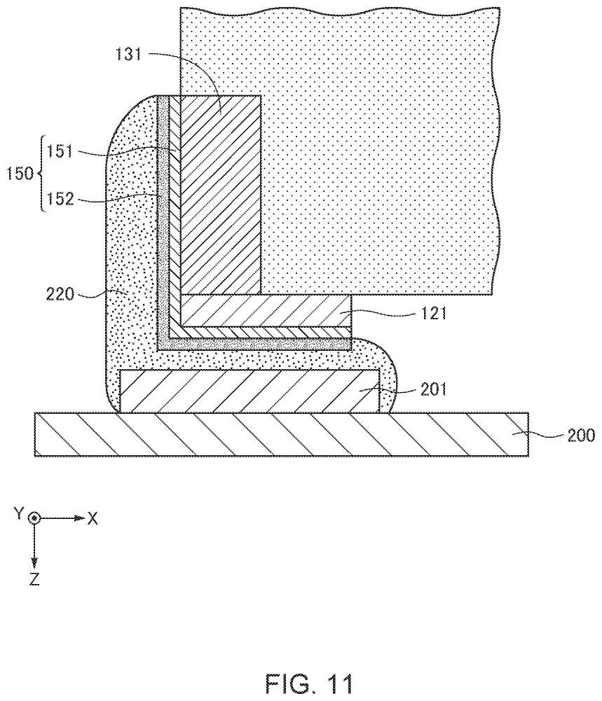

When the coil component 100 according to the present embodiment is mounted on the circuit board 200 having such a structure, the land pattern 201 and the bump conductor 131 are connected to each other through a solder 220 as illustrated in a partial cross-sectional view of FIG. 11. In a not-shown another cross section, the land pattern 202 and the bump conductor 132 are connected to each other through the solder 220. On the mounting surface S0 side of the element body 110, the solder 220 and the bump conductor 131 are connected to each other through the conductive resin layer 121; while the side surface part of the bump conductor 131 is connected to the solder 220 not through the conductive resin layer 121. This reduces a connection resistance between the solder 220 and the bump conductor 131. In addition, the conductive resin layer 121 having high flexibility is present on the mounting surface S0 side of the element body 110, so that even when stress is applied from the circuit board 200 to the coil component 100, the stress is relaxed by the conductive resin layer 121, thus increasing mounting reliability.

Further, since four terminal electrodes constituted by the bump conductors 131 and 132 and dummy bump conductors 141 and 142 are exposed to the side surfaces S1 to S4 of the element body 110, the fillet of the solder 220 is formed at four corners denoted by thick lines in FIG. 10. This allows achievement of mounting characteristics comparable with those of a four-terminal type coil component, making displacement of the mounting position in the planar and rotational directions unlikely to occur. The effect of preventing the rotational displacement becomes higher when a part of each of the bump conductor (131, 132) and dummy bump conductor (141, 142) that is exposed to the mounting surface S0 has a square planar shape. This is because when a part of each of the bump conductor (131, 132) and dummy bump conductor (141, 142) that is exposed to the mounting surface S0 has a square planar shape, the width in the Y-direction of a part of the bump conductor 131 that is exposed to the side surface S1 and the width in the X-direction of a part of the bump conductor 131 that is exposed to the side surface S3 are equal to each other, the width in the Y-direction of a part of the bump conductor 132 that is exposed to the side surface S2 and the width in the X-direction of a part of the bump conductor 132 that is exposed to the side surface S3 are equal to each other, the width in the Y-direction of a part of the dummy bump conductor 141 that is exposed to the side surface S1 and the width in the X-direction of a part of the dummy bump conductor 141 that is exposed to the side surface S4 are equal to each other, and the width in the Y-direction of a part of the dummy bump conductor 142 that is exposed to the side surface S2 and the width in the X-direction of a part of the dummy bump conductor 142 that is exposed to the side surface S4 are equal to each other.

Although the connection patterns 11 to 14, 21 to 24, 31 to 34, and 41 to 44 are also exposed to the side surfaces S1 to S4 of the element body 110, the fillet of the solder 220 is unlikely to be formed on the connection patterns 11 to 14, 21 to 24, 31 to 34, and 41 to 44 since they are separated from one another through interlayer insulating films on the side surfaces S1 to S4 of the element body 110. This prevents the height of the fillet of the solder 220 from being increased more than necessary, so that high-density mounting is not hindered. However, the fillet of the solder 220 may be formed on the connection patterns 11 to 14, 21 to 24, 31 to 34, and 41 to 44 due to deformation of a connection pattern occurring during singulation or the presence of the via conductors exposed to the side surfaces S1 to S4 of the element body 110.

As described above, according to the coil component 100 of the present embodiment, it is possible to enhance both electrical connection characteristics and stress relaxation characteristics and further to prevent displacement of the mounting position in the planar and rotational directions upon mounting.

While the preferred embodiment of the present disclosure has been described, the present disclosure is not limited to the above embodiment, and various modifications may be made within the scope of the present disclosure, and all such modifications are included in the present disclosure.

For example, although the bump conductors 131 and 132 are both exposed to the side surface S3 of the element body 110 in the above embodiment, the bump conductors 131 and 132 and dummy bump conductors 141 and 142 are not particularly limited in position. Therefore, the bump conductors 131 and 132 may be disposed at diagonal positions by interchanging the positions of the bump conductor 132 and dummy bump conductor 142.

The technology according to the present disclosure includes the following configuration examples but not limited thereto.

A coil component according to the present disclosure includes: an element body having a mounting surface, first and second side surfaces which are perpendicular to the mounting surface and parallel to each other, and third and fourth side surfaces which are perpendicular to the mounting surface and the first surface and parallel to each other; a coil conductor embedded in the element body; a first bump conductor which is connected to one end of the coil conductor and exposed to the mounting surface, the first side surface, and the third side surface; a second bump conductor which is connected to the other end of the coil conductor and exposed to the mounting surface, the second side surface, and one of the third and fourth side surfaces; a first dummy bump conductor which is exposed to the mounting surface, the first side surface and the fourth side surface; a second dummy bump conductor which is exposed to the mounting surface, the second side surface, and the other one of the third and fourth side surfaces; a first conductive resin layer which is formed on the mounting surface and connects the first bump conductor and first dummy bump conductor; and a second conductive resin layer which is formed on the mounting surface and connects the second bump conductor and the second dummy bump conductor. First side surface parts of the first bump conductor and first dummy bump conductor that are exposed to the first, third, and fourth side surfaces are each not covered at least partly with the first conductive resin layer, and second side surface parts of the second bump conductor and second dummy bump conductor that are exposed to the second, third, and fourth side surfaces are each not covered at least partly with the second conductive resin layer.

According to the present disclosure, the first and second side surface parts are not covered at least partly with the first and second conductive resin layers, so that a connection resistance can be reduced there. In addition, mounting characteristics comparable with those of a four-terminal type coil component can be achieved due to the presence of the first and second dummy bump conductors.

In the present disclosure, the first side surface part may be partly covered with the first conductive resin layer, and the second side surface part may be partly covered with the second conductive resin layer. This enhances stress relaxation characteristics in a state where the coil component is mounted on the circuit board. In this case, the height of a part of the first side surface part that is covered with the first conductive resin layer may be smaller than the height of another part of the first side surface part that is not covered with the first conductive resin layer, and the height of a part of the second side surface part that is covered with the second conductive resin layer may be smaller than the height of another part of the second side surface part that is not covered with the second conductive resin layer. This makes it possible to suppress an increase in a connection resistance due to the presence of the conductive resin layer.

In the present disclosure, the first conductive resin layer may cover a part of the first side surface part that is exposed to the third and fourth side surfaces without covering another part of the first side surface part that is exposed to the first side surface to constitute an L-shaped electrode on each of the first bump conductor and first dummy bump conductor, and the second conductive resin layer may cover a part of the second side surface part that is exposed to the third and fourth side surfaces without covering another part of the second side surface part that is exposed to the second side surface to constitute an L-shaped electrode on each of the second bump conductor and second dummy bump conductor. This makes it possible to sufficiently ensure the area of a part of each of the first and second side surface parts that is exposed without being covered with the first or second conductive resin layer.

In the present disclosure, a part of the first conductive resin layer that covers a part of the first side surface part that is exposed to the third and fourth side surfaces may be larger in thickness than another part of the first side surface part that is exposed to the first side surface, and a part of the second conductive resin layer that covers a part of the second side surface part that is exposed to the third and fourth side surfaces may be larger in thickness than another part of the second side surface part that is exposed to the second side surface. This makes rotational displacement of mounting position unlikely to occur.

In the present disclosure, the width of a part of the first side surface part that is exposed to the first side surface and the width of another part of the first side surface part that is exposed to the third and fourth side surfaces may be equal to each other, and the width of a part of the second side surface part that is exposed to the second side surface and the width of another part of the second side surface part that is exposed to the third and fourth side surfaces may be equal to each other. This makes rotational displacement of mounting position unlikely to occur.

The coil component according to the present disclosure may further include a surface treatment layer that covers the first and second conductive resin layers and the first and second side surface parts. This makes it possible to enhance wettability to a solder. The surface treatment layer may be a laminated film containing Ni and Si.

As described above, according to the present disclosure, it is possible to reduce a connection resistance in a two-terminal type coil component in which a single coil conductor is incorporated in an element body.

What is claimed is:

1. A coil component comprising:
an element body having a mounting surface, first and second side surfaces which are perpendicular to the mounting surface and parallel to each other, and third and fourth side surfaces which are perpendicular to the mounting surface and the first surface and parallel to each other;
a coil conductor embedded in the element body;
a first bump conductor which is connected to one end of the coil conductor and exposed to the mounting surface, the first side surface, and the third side surface;
a second bump conductor which is connected to other end of the coil conductor and exposed to the mounting surface, the second side surface, and one of the third and fourth side surfaces;
a first dummy bump conductor which is exposed to the mounting surface, the first side surface and the fourth side surface;
a second dummy bump conductor which is exposed to the mounting surface, the second side surface, and other one of the third and fourth side surfaces;
a first conductive resin layer which is formed on the mounting surface and connects the first bump conductor and first dummy bump conductor; and
a second conductive resin layer which is formed on the mounting surface and connects the second bump conductor and the second dummy bump conductor,
wherein a first side surface part of the first bump conductor and first dummy bump conductor that is exposed to the first, third, and fourth side surfaces is not covered at least partly with the first conductive resin layer, and
wherein a second side surface part of the second bump conductor and second dummy bump conductor that is exposed to the second, third, and fourth side surfaces is not covered at least partly with the second conductive resin layer.

2. The coil component as claimed in claim 1,
wherein the first side surface part is partly covered with the first conductive resin layer, and
wherein the second side surface part is partly covered with the second conductive resin layer.

3. The coil component as claimed in claim 2,
wherein a height of a part of the first side surface part that is covered with the first conductive resin layer is smaller than a height of another part of the first side surface part that is not covered with the first conductive resin layer, and
wherein a height of a part of the second side surface part that is covered with the second conductive resin layer is smaller than a height of another part of the second side surface part that is not covered with the second conductive resin layer.

4. The coil component as claimed in claim 2,
wherein the first conductive resin layer covers a part of the first side surface part that is exposed to the third and fourth side surfaces without covering another part of the first side surface part that is exposed to the first side surface to constitute an L-shaped electrode on each of the first bump conductor and first dummy bump conductor, and
wherein the second conductive resin layer covers a part of the second side surface part that is exposed to the third and fourth side surfaces without covering another part of the second side surface part that is exposed to the second side surface to constitute an L-shaped electrode on each of the second bump conductor and second dummy bump conductor.

5. The coil component as claimed in claim 2,
wherein a part of the first conductive resin layer that covers a part of the first side surface part that is exposed to the third and fourth side surfaces is larger in thickness than another part of the first side surface part that is exposed to the first side surface, and
wherein a part of the second conductive resin layer that covers a part of the second side surface part that is exposed to the third and fourth side surfaces is larger in thickness than another part of the second side surface part that is exposed to the second side surface.

6. The coil component as claimed in claim 1,
wherein a width of a part of the first side surface part that is exposed to the first side surface and a width of another part of the first side surface part that is exposed to the third and fourth side surfaces are equal to each other, and
wherein a width of a part of the second side surface part that is exposed to the second side surface and a width of another part of the second side surface part that is exposed to the third and fourth side surfaces are equal to each other.

7. The coil component as claimed in claim 1, further comprising a surface treatment layer that covers the first and second conductive resin layers and the first and second side surface parts.

8. The coil component as claimed in claim 7, wherein the surface treatment layer is a laminated film containing Ni and Si.
